(19) United States
(12) Patent Application Publication
(10) Pub. No.: US 2011/0261081 A1
(43) Pub. Date: Oct. 27, 2011

(54) Testing of Internet Ads

(76) Inventor: Lee S. Weinblatt, Teaneck, NJ (US)

(21) Appl. No.: 13/093,558

(22) Filed: Apr. 25, 2011

Related U.S. Application Data
(60) Provisional application No. 61/327,405, filed on Apr. 23, 2010.

(51) Int. Cl. G09G 5/00

(52) U.S. Cl. 345/671

(57) ABSTRACT

A magnification system includes a display device configured to receive and process input from a viewer to magnify portions of a displayed ad or image. The magnification system includes various magnification applications including a use magnifier and scrolling magnifier applications. The use magnifier produces a moveable window that is placed over a portion of the displayed ad or image to magnify without distortion in the moveable window that portion of the ad or image over which the window is located. The use magnifier is always available in the magnification system without activation. The scrolling magnifiers include column magnifiers and row magnifiers that may adjust the position of the ad or image on the display screen and produce a scrolling window that moves across a portion of the adjusted ad or image to magnify without distortion that portion of the adjusted ad or image over which the scrolling window is currently located.

### CROSS-REFERENCE TO RELATED APPLICATIONS

This application claims priority to, and the benefit of, Provisional U.S. Patent Application No. 61/327,405, filed Apr. 23, 2010, the entirety of which is hereby incorporated herein by reference.

### FIELD OF THE INVENTION

Example embodiments relate to a system and method for testing of ads and/or other images. In particular, example embodiments are directed to a system and method that magnifies a portion of a displayed image, e.g., an Internet ad.

### BACKGROUND OF THE INVENTION

Research services measure the effectiveness of advertisements by showing them to a test group of consumers. The advertisement can be the text of a printed advertisement (referred to as “ad copy” herein), for example. Similarly, the impact on the consumer of positioning a particular product among a number of competing products at selected positions on a rack of store shelves can be measured in a similar fashion by presenting an image of the shelves stacked with packaged products to the test group of consumers. Feedback is then solicited from the consumers about their reaction to the ad copy and product arrangement on the store shelves. In order to save money and improve efficiency, such research is increasingly being done via the Internet. However, this means that the relatively small font used for ad copy densely printed as it appears in a magazine is difficult to read on relatively small screen of a computer display. Similarly, the individual items stacked on a 5 ft. high rack of shelves are impossible to discern when reduced to fit on a computer display.

In order to aid a viewer in viewing the displayed ad or image in more detail, many conventional systems provide an option to “pull-out” an element in the ad or image from surrounding elements so that the pulled-out element is magnified in a fore-screen of the display. In order to allow for further detailed examination of the element, some conventional systems provide a “magnifying glass” that the viewer must activate and move over the element to further magnify a portion of the pulled-out element on the display screen. For example, a viewer that is viewing a web page that displays supermarket shelves containing cans of food may select a particular can to “pull-out” from the surrounding cans on a shelf so that the selected can is magnified in the fore-screen of the display. The viewer can then activate the “magnifying glass” to further enlarge a portion of the can, e.g., text on the can.

These conventional systems are a bothersome and unnatural way of viewing images, reading detailed ad copy and testing print ads on the Internet. The “magnifying glass” must be activated or loaded before it can be used by the viewer and, when used, creates distortion in the display of magnified elements. In particular, the “magnifying glass” fails to maintain a horizontal and vertical relationship between the magnified elements.

### SUMMARY OF THE INVENTION

According to an example embodiment, a magnification system includes a display device configured to magnify a portion of a displayed ad or image on a display screen. The magnification system includes various magnification applications including a use magnifier and one or more scrolling magnifiers.

The use magnifier produces a moveable window that is placed over a portion of the displayed ad or image to magnify in the moveable window that portion of the ad or image over which the moveable window is located. The use magnifier is always available when the magnification system is in use, and need not be activated before use by the user.

The scrolling magnifiers include column magnifiers and row magnifiers. The scrolling magnifiers may adjust the position of the displayed ad or image on the display screen and produce a scrolling window that moves across a portion of the adjusted ad or image to magnify in the scrolling window that portion of the adjusted ad or image over which the scrolling window is currently located.

According to another example embodiment, a magnification method may include accepting position input for a moveable window produced by a use magnifier application over a portion of an ad or image displayed on a display screen to magnify in the moveable window that portion of the ad or image over which the moveable window is located. The use magnifier is always available and need not be activated before use by the user. One or more scrolling magnifier applications may adjust a position of the displayed ad or image on the display screen and produce a scrolling window that moves across a portion of the adjusted ad or image to magnify in the scrolling window that portion of the adjusted ad or image over which the scrolling window is currently located.

The magnification applications of the magnification system maintain a horizontal and/or vertical relationship between magnified elements and do not distort the magnified elements displayed in the moveable and scrolling windows.

### BRIEF DESCRIPTION OF THE DRAWINGS

The above and/or other aspects and advantages will become more apparent and more readily appreciated from the following detailed description of example embodiments taken in conjunction with the accompanying drawings of which:

FIG. 1 is a schematic block diagram of a magnification system according to an embodiment of the invention;

FIG. 2 shows an example ad displayed in a magnification system according to an embodiment of the invention;

FIG. 3 shows a portion of an example ad in a magnification system magnified by a use magnifier according to an embodiment of the invention;

FIG. 4 shows a portion of an example ad in a magnification system magnified by an example column magnifier according to an embodiment of the invention;

FIG. 5 shows a portion of an example ad in a magnification system magnified by another example column magnifier according to an embodiment of the invention;

FIG. 6 shows a portion of an example image in a magnification system magnified by a row magnifier according to an embodiment of the invention;

FIG. 7 shows a portion of an example image in a magnification system magnified by another row magnifier according to an embodiment of the invention; and

FIG. 8 shows a portion of an example image in a magnification system magnified by still another row magnifier according to an embodiment of the invention.

### DETAILED DESCRIPTION OF THE DRAWINGS

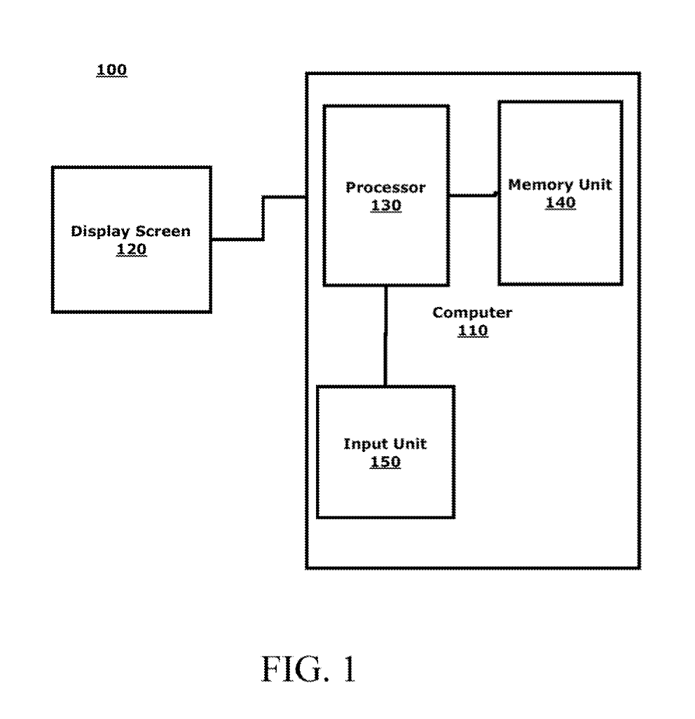

As shown in FIG. 1, a magnification system according to an embodiment of the invention includes a display device 100 configured to receive and process a viewer's input to magnify a portion of a displayed ad or image. The display device 100 may be any type of computer 110 configured to receive user input and that is connected to a display screen 120 configured to display an ad or image. The computer 110 may include a processor 130, one or more memory units 140, one or more input units 150 such as a keyboard and/or mouse, and/or various other hardware and software modules. The display screen 120 may be a touch-screen display configured to receive user input through a user's touch-based interactions with the display screen and, thus, also operate as an input unit 150 of the computer 110.

The magnification system may be implemented as one or more software modules stored in a non-transient computer readable medium, e.g., in one of the memory units 140 of the computer 110, and executed by the processor 130 to implement the magnification system and method by the display device 100.

The magnification system displays an ad or other image that is inputted or selected by a user or generated from a web page visited by the user on the display screen 120 of the display device 100. Before the ad or image is displayed to the user, an instructional “pop-up” window may be displayed to the user that provides the user with instructions for using the magnification system.

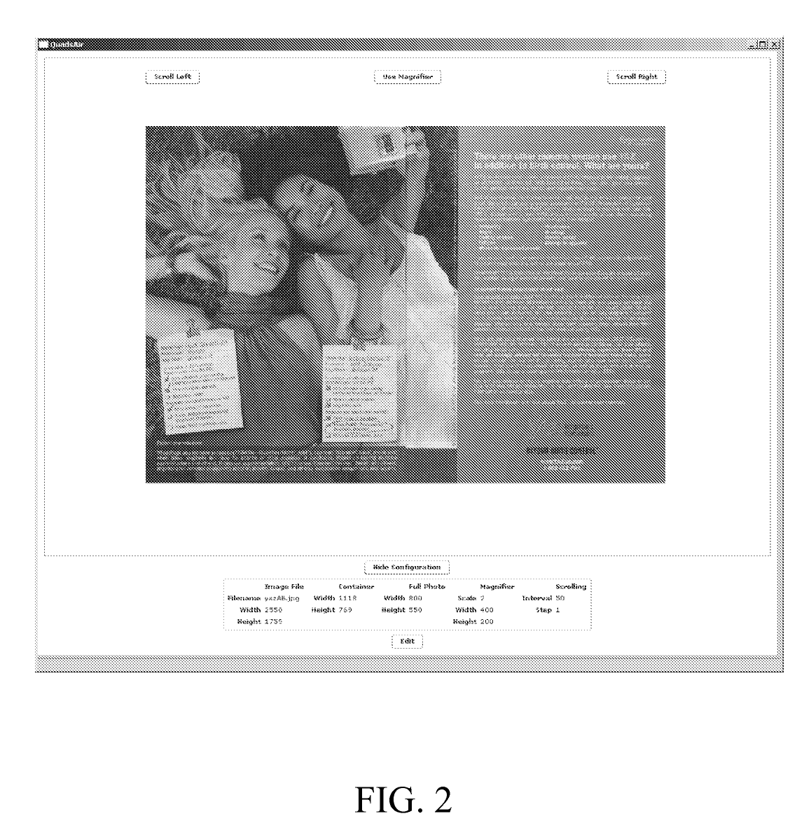

FIG. 2 shows an example ad displayed in a magnification system according to an embodiment of the invention.

The magnification system includes various magnification applications including a use magnifier application and scrolling magnifier applications that are configured to magnify a portion of the displayed ad or image. The magnification applications of the magnification system do not distort the magnified elements. For example, the magnification applications maintain a horizontal and/or vertical relationship between magnified elements on the display.

The magnification applications of the magnification system may be integrated with a web browser or other known computer application that is configured to display ads or other images. Alternatively, the magnification applications of the magnification system may be a separate application configured to implement the magnification system.

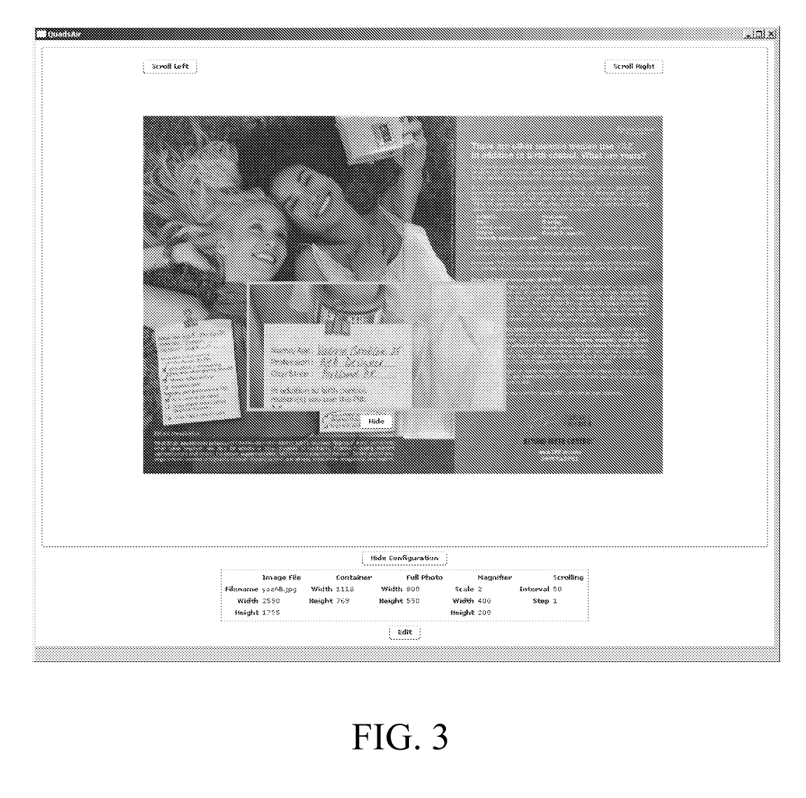

The use magnifier application provides a moveable window that is positioned by the user over a portion of the ad or image to magnify within the moveable window that portion of the ad or image over which the window is located. FIG. 3 shows an example moveable window of a use magnifier application. The use magnifier is always available to the user when the magnification system is in use and need not be activated or loaded before use by the user. For example, the use magnifier may always be available in collapsed form on the display screen 120, e.g., at the top of an open browser window. Alternatively, a button may be provided on the display screen 120 that allows the user to “pop-up” (use magnifier button) or “hide” (hide button) the use magnifier as shown in FIGS. 2-3. Regardless, the user need not activate the use magnifier by retrieving the user magnifier application from a menu or loading the use magnifier application before using the use magnifier.

FIG. 3 shows a portion of an example ad in a magnification system magnified by the use magnifier according to an embodiment of the invention. As shown in FIG. 3, the use magnifier provides a moveable window that magnifies a portion of the displayed ad depicted in FIG. 2. As previously noted, the use magnifier maintains a horizontal and/or vertical relationship between the magnified elements in the moveable window including any text magnified in the moveable window. The user may “drag” the moveable window over any portion of the displayed ad in order to magnify that portion of the ad. If the user is finished using the use magnifier, the user can “click” the “hide” button as shown in FIG. 3 to hide the moveable window from view or to re-collapse the moveable window.

The user sets parameters for the use magnifier application. Alternatively, the user can use default parameters that have been previously set for the use magnifier application or that are set for the use magnifier application by the magnification system based on the type or size of an ad or image currently displayed by the magnification system.

The parameters for the use magnifier application include a height and width of the moveable window and a magnification ratio of the magnified portion of the ad or image displayed in the moveable window. The magnification ration is a size ratio between elements in the displayed ad or image and a magnified version of those elements in the moveable window. The user may adjust the size of the moveable window of the use magnifier by dragging an edge of the window to increase or decrease its height and/or width. The current parameters for the use magnifier may be displayed in the magnification system to the user on the display screen 120. FIG. 3 shows an example where some of the parameters for the magnification applications are displayed to the user on the display screen 120. Alternatively, the current parameters for the use magnifier may be hidden from the user's view and accessible through a menu or other means to set or change the parameters.

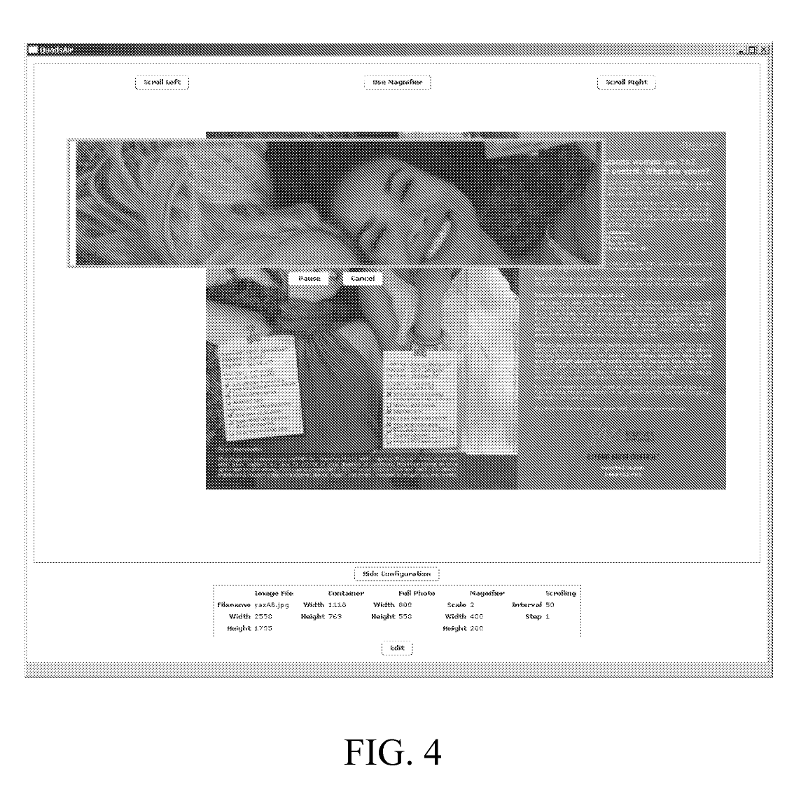

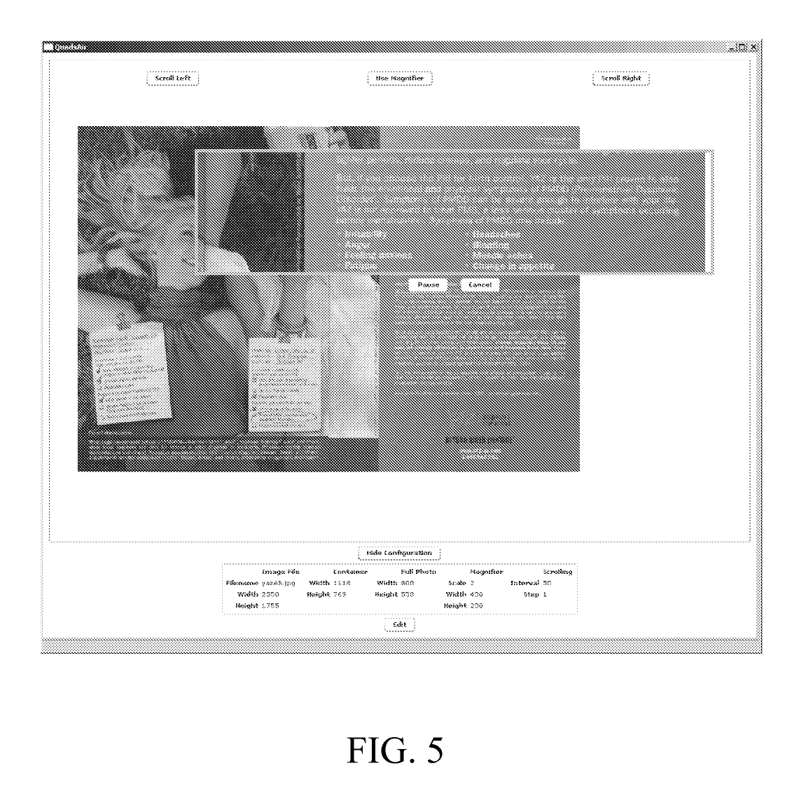

When a portion along one side (e.g. left side) of the ad or image is being magnified, the use magnifier application can adjust the position of the displayed ad or image on the display screen 120 toward the other side (e.g. right side), so that more of the ad or image can be reached by the moveable window, as explained in greater detail below with respect to FIGS. 4 and 5.

FIGS. 4-8 show examples of scrolling magnifier applications in a magnification system according to an embodiment of the invention. The scrolling magnifier applications include column magnifier applications and row magnifier applications that provide scrolling windows that magnify the portion of the ad or image over which the scrolling windows are located. Each scrolling magnifier application provides a scrolling window that moves, e.g., moves automatically, across a portion of the displayed ad or image in a desired or, alternatively, predetermined path and/or direction and that magnifies in the scrolling window that portion of the ad or image over which the scrolling window is currently located.

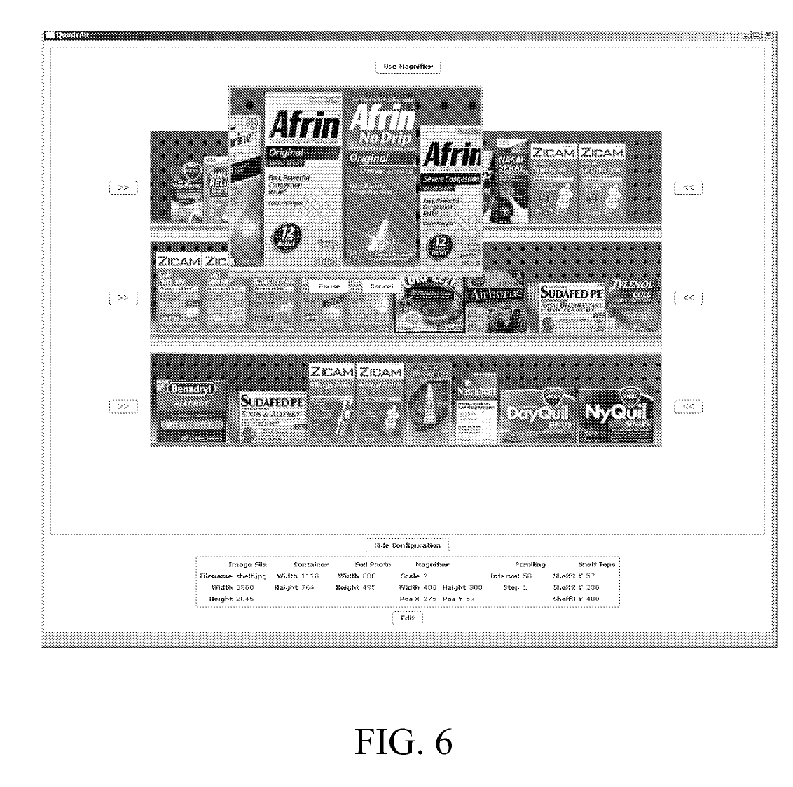

FIGS. 4-5 show controls for scrolling right and scrolling left column magnifiers. However, the column magnifiers are not limited thereto and may include any desired number of column magnifiers. The user may click on the “Scroll Right” or “Scroll Left” button as shown in FIGS. 4-5 to start or re-start a scrolling operation of the designated scrolling magnifier. The scrolling row magnifiers include, but are not limited to scrolling top, scrolling middle and scrolling bottom row magnifiers. However, the row magnifiers may include any desired number of row magnifiers, for example, a row magnifier for each shelf of a shelving system shown in an image of a supermarket shelving system may be provided by a magnification system according to an embodiment of the invention. FIGS. 6-8 show controls for scrolling top, middle and bottom magnifiers. The user may click on the “>>” or “<<” button to start or re-start a scrolling operation of the designated scrolling magnifier for a corresponding row.

Each scrolling magnifier application includes a pause/continue control, e.g., in the form of a Pause/Continue button located near the scrolling window as shown in FIGS. 4-8, which pauses or continues the scrolling operation, i.e., which pauses or continues the movement of the scrolling window across the displayed ad or image. This button toggles between Pause and Continue. It appears in the drawings as “Pause”. However, when it is touched it toggles to “Continue”. The scrolling magnifier applications may adjust the position of the displayed ad or image on the screen and scroll the scrolling window across a portion of the adjusted ad or image to magnify a portion of the adjusted ad or image in the scrolling window. As previously noted, the scrolling magnifiers maintain a horizontal and/or vertical relationship between the magnified elements of the magnified display in the scrolling windows including any text in the magnified display. The scrolling magnifiers may be started or re-started by the user through scroll controls, e.g., in the form of scroll direction buttons, which start the automatic scrolling of the scrolling windows across the displayed ad or image, as shown in FIGS. 4-8.

As mentioned above, when a portion along one side of the ad or image is being magnified, the use magnifier application can adjust the position of the displayed ad or image on the display screen 120 toward the other side. For example, FIG. 4 shows the displayed ad shifted to the right. FIG. 5., in contrast, shows the displayed ad shifted to the left. The scrolling window stops scrolling and disappears when the scrolling window reaches the end of the ad or image in the direction across which the scrolling window is scrolling, i.e., when the scrolling windows reaches the end of its path.

The column magnifiers provide scrolling windows that scroll from top to bottom or bottom to top of the displayed ad or image. The row magnifiers provide scrolling windows that may scroll from left to right or right to left of the displayed ad or image. For example, in the case of the Scroll column magnifier, the scrolling window can scroll from top to bottom and will stop scrolling and disappear when it runs out of new image to magnify. Alternatively, the user can manually end the scrolling operation, e.g., by clicking inside the magnifying bar during scrolling, or by clicking the Cancel button. The scrolling direction of a scrolling window for each scrolling magnifier application can be selected by the user.

The user sets parameters for the scrolling magnifier applications. Alternatively, the user can use default parameters that have been previously set for the scrolling magnifiers or that are set by the magnification system based on the type of ad or image currently displayed by the magnification system.

The scrolling parameters include a height and width of the scrolling window, a magnification ratio for the magnified portion of the ad or image shown in the scrolling window, a scrolling interval time, a scrolling step size, and/or a scrolling direction and/or path. The magnification ratio is a size ratio between elements in the displayed ad or image and a magnified version of those elements in the scrolling window. The scrolling interval is a time between movement of the scrolling window, and the scrolling step size is a distance that the scrolling window is moved at each interval. The user may additionally move the scrolling window in its scrolling path by selecting the scrolling window and “dragging” the scrolling window forward or backward along its directional path. Scrolling magnifier controls e.g., as shown in FIGS. 4-8 and discussed above, may be provided at edges of the displayed ad or image to allow the user to select the desired scrolling magnifier for a particular row and the direction of scrolling.

FIG. 4 shows a portion of an example ad in a magnification system magnified by a scroll left magnifier according to an embodiment of the invention. As shown in FIG. 4, the scrolling window of the Scroll Left magnifier shifts the ad to the right and magnifies the left side of the ad. For example, FIG. 4 shows the left page of an ad for a magazine magnified by the Scroll Left magnifier. The scrolling window of the Scroll Left magnifier may be configured to move from top to bottom of the ad or from bottom to top of the ad while magnifying those portions of the ad over which the scrolling window is located throughout the path of the scrolling window.

FIG. 5 shows a portion of an example ad in a magnification system magnified by a Scroll Right magnifier according to an embodiment of the invention. As shown in FIG. 5, the scrolling window of Right Scroll magnifier shifts the ad to the left and magnifies the right side of the ad. For example, FIG. 5 shows the right page of an ad for a magazine magnified by the Scroll Right magnifier. The Scroll Right magnifier may be configured to scroll from top to bottom of the ad or from bottom to top of the ad while magnifying those portions of the ad over which the scrolling window is located throughout the path of the scrolling window.

FIG. 6 shows a portion of an example image in a magnification system magnified by a row magnifier according to an embodiment of the invention. As shown in FIG. 6, the scrolling window of the row magnifier magnifies a top portion of the image. For example, FIG. 6 shows a portion of the top shelf of a supermarket shelf magnified by a scrolling window of the scroll top magnifier, wherein those portions of the top shelf shown as not currently magnified by the scrolling window in FIG. 6 have already been or will be magnified by the scrolling window during a path of movement of the scrolling window. The example shown in FIG. 6 does not shift the image toward the bottom of the display screen for the scrolling top magnifier application. However, the row magnifiers may shift the image in a direction opposite a side of the displayed ad or image that is to be magnified by the scrolling window so that the side of the ad or display image across which the scrolling operation is to take place can take advantage of the available space of the display screen 120. The row magnifiers can be selected by the user to scroll from left to right of the image or from right to left of the image. For example, FIG. 6 shows buttons “<<” and “>>” provided at edges of the displayed ad or image to allow the user to select the desired scrolling magnifier for a particular row and the direction of scrolling.

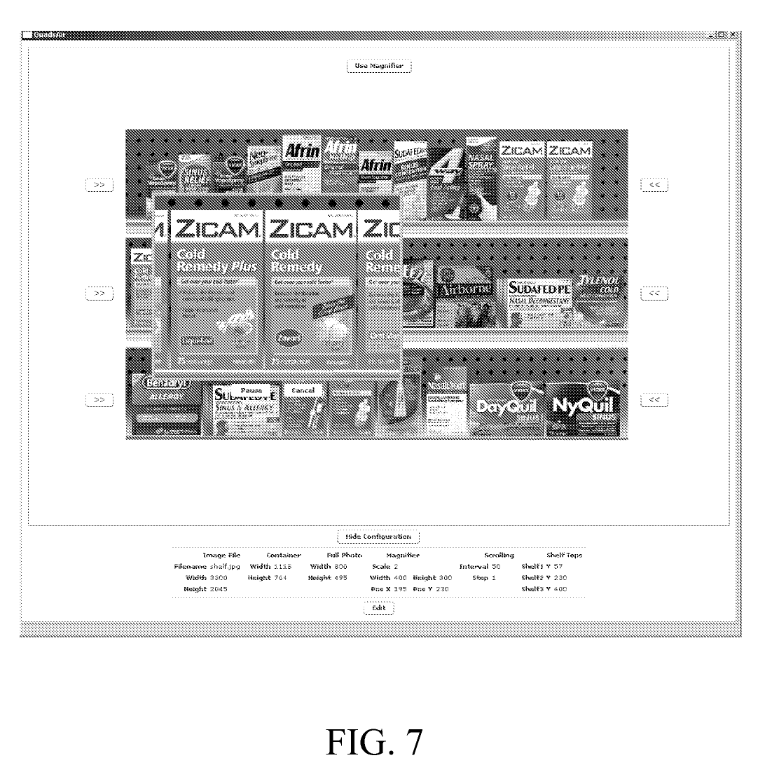

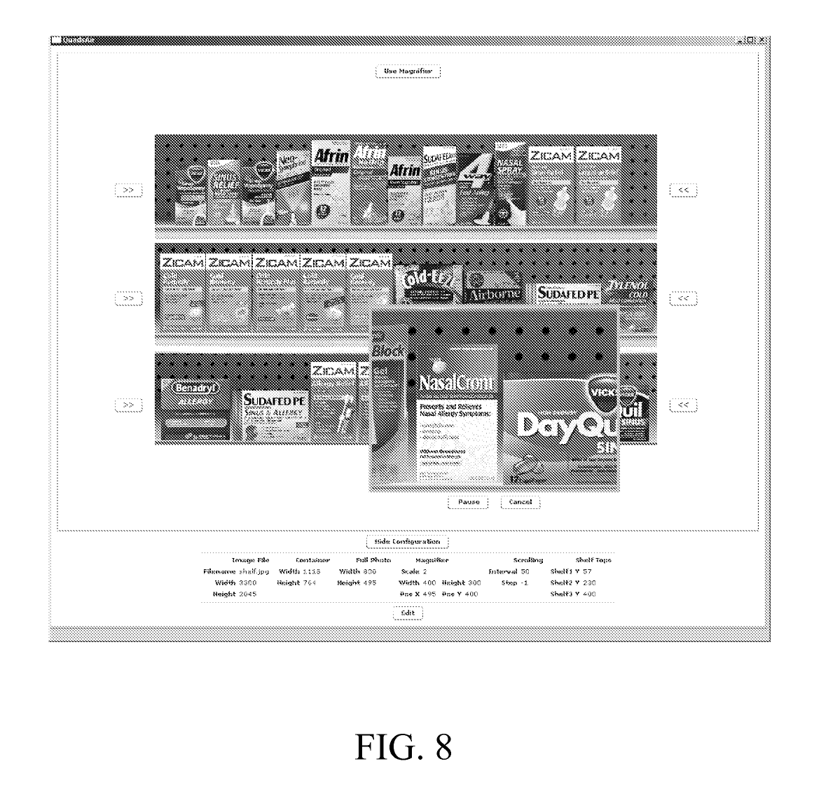

FIG. 7 shows a portion of an example image in the magnification system magnified by another row magnifier according to an embodiment of the invention. FIG. 8 shows a portion of an example image in the magnification system magnified by still another row magnifier according to an embodiment of the invention. As shown in FIGS. 7-8, row magnifiers for each of the shelves of the supermarket shelving system may be provided by the magnification system. The row magnifiers shown in FIGS. 7-8 operate similarly to the row magnifier discussed above with respect to FIG. 6 and, therefore, a detailed description of the row magnifiers of FIGS. 7-8 is omitted in the interest of brevity.

Although described separately in the foregoing description, the row magnifiers and column magnifiers may be employed together in a magnification system configured to magnify both columns and rows of a displayed ad or image.

Example embodiments may include scrolling diagonal magnifier applications that scroll a magnifying window across an image at a diagonal path that may be set by a user.

Although example embodiments have been shown and described in this specification and figures, it would be appreciated by those skilled in the art that changes may be made to the illustrated and/or described example embodiments without departing from their principles and spirit.

What is claimed is:

1. A system for displaying and magnifying an image, the system comprising:
a display device configured to display an ad or image on a display screen;
a use magnifier configured to produce a moveable window that is placed over a portion of the displayed ad or image to magnify in the moveable window that portion of the ad or image over which the moveable window is located, wherein the use magnifier is always available when the system is in use without activation by a user; and
one or more scrolling magnifiers including at least one of a column magnifier and a row magnifier, wherein the one or more scrolling magnifier adjust the position of the displayed ad or image on the display screen and produce a scrolling window that moves across a portion of the adjusted ad or image to magnify in the scrolling window that portion of the adjusted ad or image over which the scrolling window is currently located.

2. The system of claim 1, wherein the use magnifier and the one or more scrolling magnifiers maintain at least one of a horizontal and a vertical relationship between magnified elements.

3. The system of claim 1, wherein the moveable window of the use magnifier is always available in collapsed form on the display screen.

4. The system of claim 1, wherein parameters for a height and width of the moveable window and a magnification ratio of the magnified portion of the displayed ad or image are configurable by the user.

5. The system of claim 1, wherein if the portion of the displayed ad or image magnified in the moveable window is at a side of the displayed ad or image, the use magnifier adjusts the position of the displayed ad or image on the display screen toward an opposite side.

6. The system of claim 1, wherein the one or more scrolling windows move automatically across the portion of the adjusted ad or image in a predetermined path and direction.

7. The system of claim 1, wherein the one or more scrolling magnifiers include a plurality column magnifiers and a plurality of row magnifiers, a control on the display screen for starting and restarting the scrolling operation for each of the column and row magnifiers, a control on the display screen for pausing and continuing the scrolling operation of each of the column and row magnifiers.

8. The system of claim 1, wherein if the portion of the displayed ad or image magnified in the scrolling window is at a side of the displayed ad or image, the scrolling magnifier adjusts the position of the displayed ad or image on the display screen toward an opposite side.

9. The system of claim 1, wherein parameters for a height and width of the scrolling window, a magnification ratio of the magnified portion of the displayed ad or image, a scrolling interval time, a scrolling step size and a scrolling direction and path are configurable by the user.

10. A method for displaying and magnifying an image, the method comprising:
displaying an ad or image on a display screen;
accepting position input for a moveable window produced by a use magnifier over a portion of the ad or image displayed on the display screen to magnify in the moveable window that portion of the ad or image over which the moveable window is located, wherein the use magnifier is always available when the system is in use without activation by a user; and
adjusting with one or more scrolling magnifiers a position of the displayed ad or image on the display screen and producing a scrolling window that moves across a portion of the adjusted ad or image to magnify in the scrolling window that portion of the adjusted ad or image over which the scrolling window is currently located.

11. The method of claim 10, wherein at least one of a horizontal and a vertical relationship between magnified elements magnified by the use magnifier and the one or more scrolling magnifiers is maintained.

12. The method of claim 10, wherein the moveable window of the use magnifier is always available in collapsed form on the display screen.

13. The method of claim 10, setting, by a user, parameters for a height and width of the moveable window and a magnification ratio of the magnified portion of the displayed ad or image.

14. The method of claim 10, wherein if the portion of the displayed ad or image magnified in the moveable window is at a side of the displayed ad or image, the use magnifier adjusts the position of the displayed ad or image on the display screen toward an opposite side.

15. The method of claim 10, wherein the one or more scrolling windows move automatically across the portion of the adjusted ad or image in a predetermined path and direction.

16. The method of claim 10, wherein the one or more scrolling magnifiers comprise a plurality column magnifiers and a plurality of row magnifiers, and wherein the magnification method further comprises providing a control on the display screen for starting and restarting the scrolling operation for each of the column and row magnifiers and a control on the display screen for pausing and continuing the scrolling operation of each of the column and row magnifiers.

17. The method of claim 10, wherein if the portion of the displayed ad or image magnified in the scrolling window is at a side of the displayed ad or image, the scrolling magnifier adjusts the position of the displayed ad or image on the display screen toward an opposite side.

18. The method of claim 10, setting, by the user, parameters for a height and width of the scrolling window, a magnification ratio of the magnified portion of the displayed ad or image, a scrolling interval time, a scrolling step size and a scrolling direction and path.

19. A non-transitory computer readable medium storing a computer program comprising instructions which when executed by a computer perform a method for displaying and magnifying an image, the method comprising:
displaying an ad or image on a display screen;
accepting position input for a moveable window produced by a use magnifier over a portion of the ad or image displayed on the display screen to magnify in the moveable window that portion of the ad or image over which the moveable window is located, wherein the use magnifier is always available when the system is in use without activation by a user; and
adjusting with one or more scrolling magnifiers a position of the displayed ad or image on the display screen and producing a scrolling window that moves across a portion of the adjusted ad or image to magnify in the scrolling window that portion of the adjusted ad or image over which the scrolling window is currently located.
